(19) United States
(12) Patent Application Publication
(10) Pub. No.: US 2013/0268141 A1
(43) Pub. Date: Oct. 10, 2013

(54) Vehicle Intelligent Key Device, Remote Control System, and Method for Driving a Passenger Vehicle

(71) Applicants: SHENZHEN BYD AUTO R&D COMPANY LIMITED, Shenzhen (CN); BYD COMPANY LIMITED, Shenzhen (CN)

(72) Inventors: Xiaowen DU, Shenzhen (CN); Yongzeng ZHANG, Shenzhen (CN); Yilin ZHONG, Shenzhen (CN); Bo FAN, Shenzhen (CN)

(21) Appl. No.: 13/857,683

(22) Filed: Apr. 5, 2013

(30) Foreign Application Priority Data
Apr. 6, 2012 (CN) 201210099717.7

(51) Int. Cl. G06F 17/00

(52) U.S. Cl. CPC G06F 17/00
USPC 701/2

(57) ABSTRACT

A remote control system for remotely driving a passenger vehicle, comprising a key controller configured to receive a signal sent by a vehicle intelligent key device and to generate a remote signal according to the received signal, a body control module configured to control the passenger vehicle to enter into a remote control mode according to the remote signal, and an automatic transmission configured to control a gear of a gearbox of the passenger vehicle to switch according to the remote signal.

### CROSS-REFERENCE TO RELATED APPLICATION

This application is based upon and claims benefit of priority from Chinese Patent Application Serial No. 201210099717.7, filed with the State Intellectual Property Office of P. R. China on Apr. 6, 2012, the entire contents of which are incorporated herein by reference.

### FIELD

The present disclosure relates to vehicle technology and, more particularly, to a vehicle intelligent key device, a remote control system for driving a vehicle, and a remote control method for driving a vehicle.

### BACKGROUND

Nowadays, as the number of vehicles increases, it becomes more and more difficult to find a parking space. Especially in big cities, parking spaces are limited and are much narrower. Therefore, it is difficult for a user to get in or out of a vehicle since the parking space is very narrow and can only accommodate the vehicle.

Accordingly, there is a need to control a vehicle outside the vehicle, so that the user does not need to get in or out of the vehicle in the narrow parking space.

### SUMMARY

In accordance with the present disclosure, there is provided a remote control system for remotely driving a vehicle. The remote control system comprises a key controller configured to receive a signal sent by a vehicle intelligent key device and to generate a remote signal according to the received signal, a body control module configured to control the vehicle to enter into a remote control mode according to the remote signal, and an automatic transmission configured to control a gear of a gearbox of the vehicle to switch according to the remote signal.

Further in accordance with the present disclosure, there is provided a vehicle intelligent key device comprising a starting key, a direction control key, a control module coupled to the starting key and the direction control key and configured to generate a signal when the starting key or the direction control key is activated, and a wireless communication module coupled to the control module and configured to send the signal.

Further in accordance with the present disclosure, there is provided a remote control method for remotely driving a vehicle. The method comprises receiving, by a key controller, a signal sent by a vehicle intelligent key device, generating, by the key controller, a remote signal according to the received signal, controlling, by a body control module, the vehicle to enter into a remote control mode according to the remote signal and controlling an operational state of the vehicle according to the remote signal.

Further in accordance with the present disclosure, there is provided a remote control method for driving a vehicle. The method comprises activating a starting key or a direction control key on a vehicle intelligent key device, generating a signal when the starting key or the direction control key is activated, and sending the signal via a wireless communication module.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram showing a remote control system for driving a vehicle according to an exemplary embodiment of the present disclosure.

FIG. 2 is a block diagram showing a remote control system in a remote starting mode according to an exemplary embodiment of the present disclosure.

FIG. 3 is a block diagram showing a remote control system in a remote control mode according to an exemplary embodiment of the present disclosure.

FIG. 4 is a block diagram of a remote control system in a remote turning mode according to an embodiment of the present disclosure.

FIG. 5 is a block diagram showing a vehicle intelligent key device according to an exemplary embodiment of the present disclosure.

FIG. 6 is a schematic view of a control panel of a vehicle intelligent key device according to an exemplary embodiment of the present disclosure.

FIG. 7 is a flow chart showing a remote control method for driving a vehicle according to an exemplary embodiment of the present disclosure.

FIGS. 8A and 8B are a flow chart showing a method for controlling the vehicle to start a remote control mode according to an exemplary embodiment of the present disclosure.

FIGS. 9A and 9B are a flow chart showing a method for controlling the vehicle to move forward according to an exemplary embodiment of the present disclosure.

FIGS. 10A and 10B are a flow chart showing a method for controlling the vehicle to move backward according to an exemplary embodiment of the present disclosure.

FIG. 11 is a flow chart showing a method for controlling the vehicle to turn left or right according to an exemplary embodiment of the present disclosure.

FIG. 12 is a flow chart showing a method for controlling the vehicle to quit the remote control mode according to an exemplary embodiment of the present disclosure.

FIG. 13 is a flow chart showing a method for controlling the vehicle to quit the remote control mode according to another exemplary embodiment of the present disclosure.

### DETAILED DESCRIPTION

Embodiments of the present disclosure will be described in detail with reference to drawings. Same or similar elements and elements having same or similar functions will be referred to by same or like reference numerals throughout the present disclosure. The embodiments described herein with reference to the drawings are explanatory and illustrative, which are used to help understand the present disclosure. The embodiments shall not be construed to limit the present disclosure.

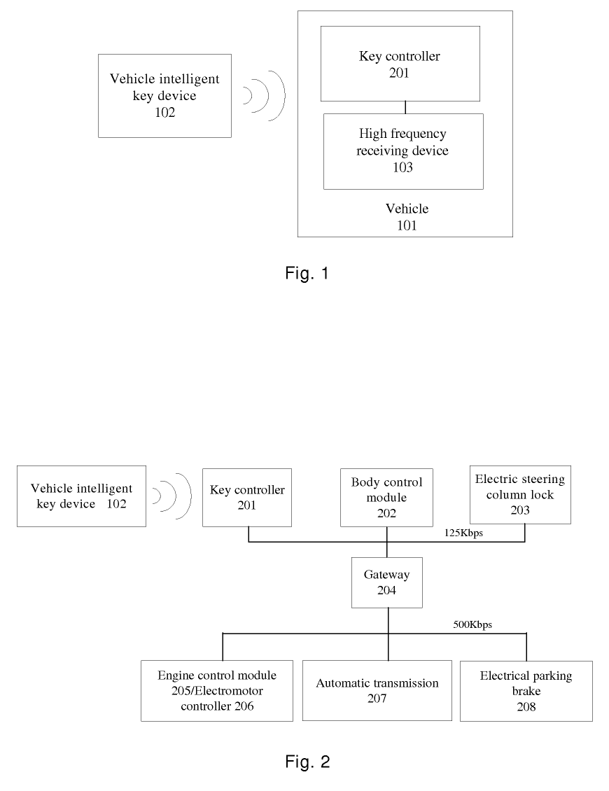

The remote control system for driving a vehicle consistent with embodiments of the present disclosure will be described in detail with reference to FIGS. 1-4.

FIG. 1 is a block diagram showing a remote control system consistent with embodiments of the present disclosure for controlling a vehicle. As shown in FIG. 1, the remote control system comprises a vehicle 101 and a vehicle intelligent key device 102. The vehicle intelligent key device 102 is configured to send a starting signal or a control signal to the vehicle 101. The vehicle 101 is configured to receive the starting signal or the control signal sent by the vehicle 101. The vehicle 101 starts a remote control mode according to the starting signal, and controls a driving thereof according to the control signal. Controlling the driving the vehicle 101 may comprise controlling of a steering system, a speed control system, and a braking system of the vehicle 101.

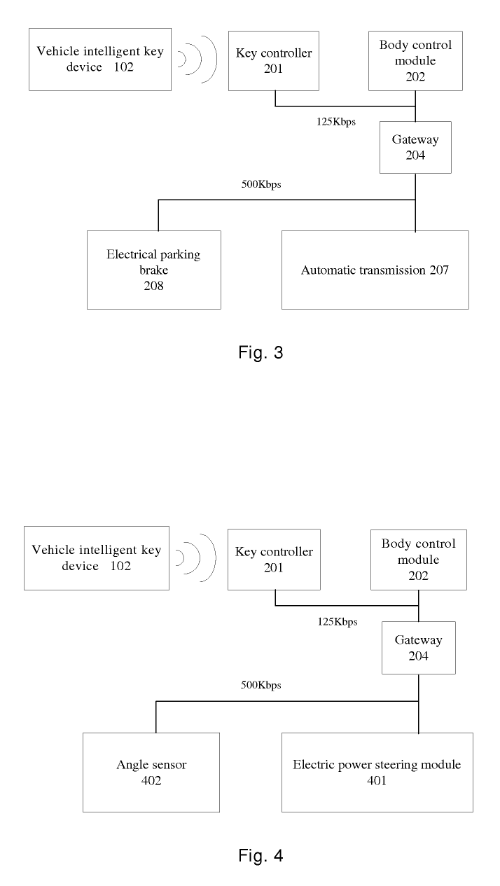

FIG. 2 is a block diagram showing more details of a remote control system consistent with embodiments of the present disclosure. As shown in FIG. 2, if the vehicle 101 is a fuel vehicle, the vehicle 101 further comprises a key controller 201, a body control module (BCM) 202, an electric steering column lock (ECL) 203, a gateway 204, an engine control module (ECM) 205, an automatic transmission 207, and an electrical parking brake (EPB) 208.

In one example of the present disclosure, the automatic transmission 207 may be a dual clutch transmission (DCT).

Also shown in FIG. 2, if the vehicle 101 is an electric vehicle, the vehicle 101 further comprises a key controller 201, a body control module 202, an electric steering column lock 203, a gateway 204, an electromotor controller 206, an automatic transmission 207, and an electrical parking brake 208. The key controller 201, the body control module 202, the electric steering column lock 203, the engine control module (ECM) 205/electromotor controller 206, the automatic transmission 207, and the electrical parking brake 208 are configured to communicate with each other through the gateway 204. Specifically, the key controller 201 may receive the starting signal or the control signal sent by the vehicle intelligent key device 102, and generate a remote starting signal or a remote control signal according to the starting signal or the control signal. In one embodiment of the present disclosure, the starting signal and the control signal may be high-frequency signals.

In one embodiment of the present disclosure, as shown in FIG. 1, the vehicle 101 further comprises a high-frequency receiving device 103 configured to receive the starting signal and the control signal sent by the vehicle intelligent key device 102, to demodulate the starting signal and the control signal and send forward the signals to the key controller 201.

The function of the each functional module of the vehicle 101 will be described in detail below.

The body control module 202 is configured to receive the remote starting signal and the remote control signal sent by the key controller 201, to control the vehicle 101 to power on. The electric steering column lock 203 is configured to receive an unlocking signal sent by the body control module 202 and to unlock a steering wheel of the vehicle 101 according to the unlocking signal. The gateway 204 is configured to communicate with the key controller 201, the body control module 202, and the electric steering column lock 203, respectively. In other words, the gateway 204 is configured to realize a high/low speed network communication in the vehicle 101. For example, the high speed may be 500 Kbps (bit per second) and the low speed may be 125 Kbps. The engine control module 205 is configured to communicate with the gateway 204 and to control an engine of the vehicle 101 to start according to the remote starting signal transmitted by the key controller 201 via the gateway 204. The electromotor controller 206 is configured to control the vehicle 101 to start according to the remote starting signal transmitted by the gateway 204. The automatic transmission 207 is configured to communicate with the gateway 204, and to control a gear of a gearbox of the vehicle 101 to switch and to generate a parking control signal according to the remote control signal transmitted by the key controller 201 via the gateway 204, in which the switching of the gear of the gearbox of the vehicle 101 refers to the switching of a gear shifts of the speed control system of the vehicle 101. The electrical parking brake 208 is configured to communicate with the gateway 204 and the automatic transmission 207, and to control the vehicle 101 to park according to the parking control signal.

In one embodiment of the present disclosure, as shown in FIG. 2, the key controller 201 is further configured to detect whether the vehicle intelligent key device 102 is inside the vehicle 101 after receiving the starting signal or the control signal, and to send the remote starting signal and the remote control signal to the body control module 202 when the vehicle intelligent key device 102 is outside the vehicle 101.

The body control module 202 is further configured to detect a state of the electrical parking brake 208 and a gear of a gearbox of the vehicle. When the body control module detects that the state of the electrical parking brake 208 is “normal” and the gear of the gearbox of the vehicle is in “Parking”, for a fuel vehicle, the engine control module 205 performs a pairing operation with the key controller 201 and, if the pairing operation is successful, controls the engine to start. On the other hand, for an electric vehicle, the electromotor controller 206 controls the power system of the vehicle 101 to start. After the engine and/or the power system are started, the remote starting of the vehicle 101 is finished. The vehicle 101 enters into a remote control mode.

In some embodiments, the body control module 202 is further configured to control the engine and/or the power system to quit the remote control mode if any one of the following conditions is satisfied:

1) the body control module 202 does not detect a remote control signal from the key control 201 within a first time threshold;

2) the body control module 202 does not detect a remote control mode signal from the automatic transmission 207 within a second time threshold;

3) the body control module 202 detects a quit remote control mode signal sent by the automatic transmission 207;

4) the body control module 202 detects that a door of the vehicle 101 is open;

5) the body control module 202 detects that a brake pedal or an accelerator pedal of the vehicle 101 is pressed down;

6) the body control module 202 detects a speed signal of the vehicle 101, and determines that a current speed of the vehicle 101 is higher than a speed threshold, or the body control module 202 does not detect a speed signal;

7) the body control module 202 receives a remote unlocking signal or a micro switch unlocking signal sent by the key controller 201.

In one exemplary embodiment of the present disclosure, the first time threshold may be 10 minutes, the second time threshold may be 2 seconds, the speed threshold may be 2 km/h. The above numerical values of the first time threshold, the second time threshold, and the speed threshold are explanatory and illustrative, but shall not be construed to limit the present disclosure. The numerical values of the first time threshold, the second time threshold, and the speed threshold may be other numerical values depending on driving habits of different users.

In some embodiments of the present disclosure, the automatic transmission 207 is further configured to send a parking cable engaging signal to the electrical parking brake 208 and to set the gear of the gearbox of the speed control system to “Parking” when the engine and/or the power system quit the remote control mode.

In one exemplary embodiment of the present disclosure, the remote control signal may be any one of a remote forward signal, a remote backward signal, or a remote turning signal. The remote forward signal is configured to control the vehicle to move forward, the remote backward signal is configured to control the vehicle to move backward, and the remote turning signal is configured to control the vehicle to turn left or right.

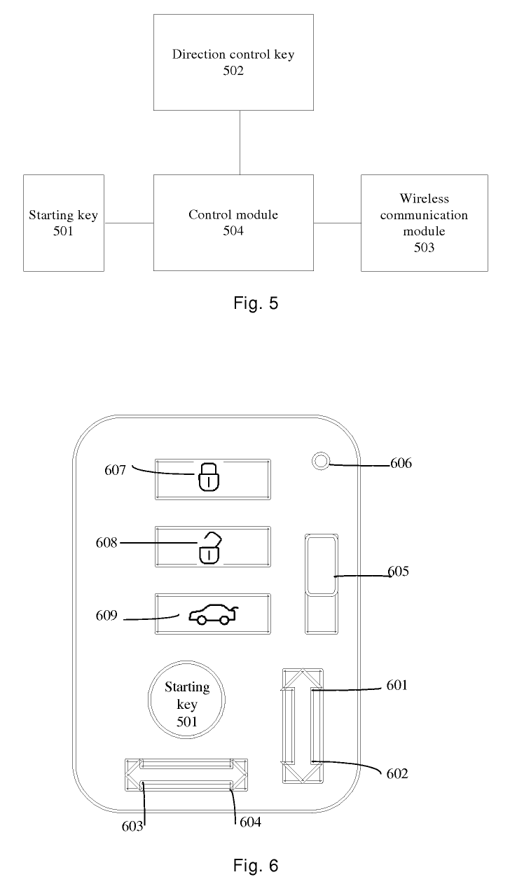

FIG. 3 is a block diagram showing a remote control system in a remote control mode according to an exemplary embodiment of the present disclosure. As shown in FIG. 3, when the automatic transmission 207 receives a remote forward signal and detects that the engine and/or the power system are in the remote control mode, the automatic transmission 207 controls the electrical parking brake 208 to disengage the parking cable, to feed back a state of the parking cable, and to set the gear of the gearbox to “Driving.” The vehicle 101 will move forward at a speed lower than the speed threshold (for example, 2 km/h).

In another exemplary embodiment of the present disclosure, as shown in FIG. 3, when the automatic transmission 207 receives a remote backward signal and detects that the engine and/or the power system are in the remote control mode, the automatic transmission 207 controls the electrical parking brake 208 to disengage the parking cable, to feed back the state of the parking cable, and to set the gear of the gearbox to “Reverse.” The vehicle 101 will move backward at a speed lower than the speed threshold (for example, 2 km/h).

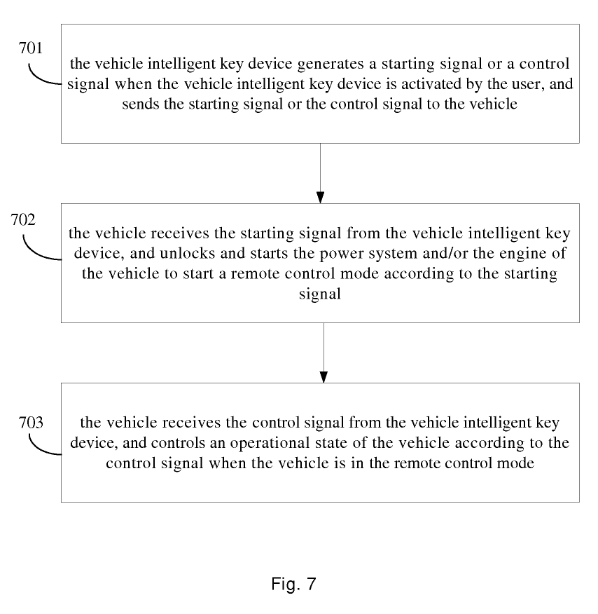

FIG. 4 is a block diagram showing a remote control system in a remote turning mode according to an exemplary embodiment of the present disclosure. As shown in FIG. 4, the remote control system further includes an electric power steering module (EPS) 401 and an angle sensor 402. The electric power steering module 401 is configured to receive the remote turning signal sent by the key controller 201 and to control the steering wheel of the vehicle 101 to rotate according to the remote turning signal when the engine and/or the power system are in the remote control mode. The angle sensor 402 is configured to detect the rotation angle of the steering wheel and to feed back the rotation angle to the electric power steering module 401. The electric power steering module 401 controls a steering column of the vehicle 101 to turn left or right at a certain speed.

With the remote control system consistent with embodiments of the present disclosure, a vehicle could be controlled to move at a speed lower than a speed threshold, such as, for example, 2 km/h, within a visual range (for example, 2 km/h). The operation is simple and easy. Users could control the vehicle, from outside the vehicle, to move forward or to move backward at a speed lower than a speed threshold (for example, 2 km/h), or control the vehicle to turn left or right so as to park or take a vehicle in a narrow space.

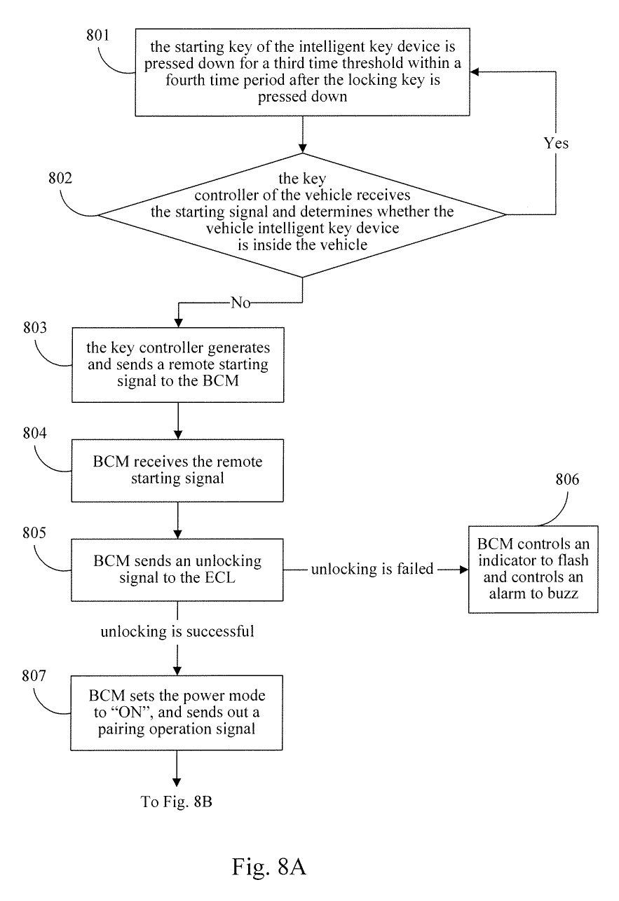

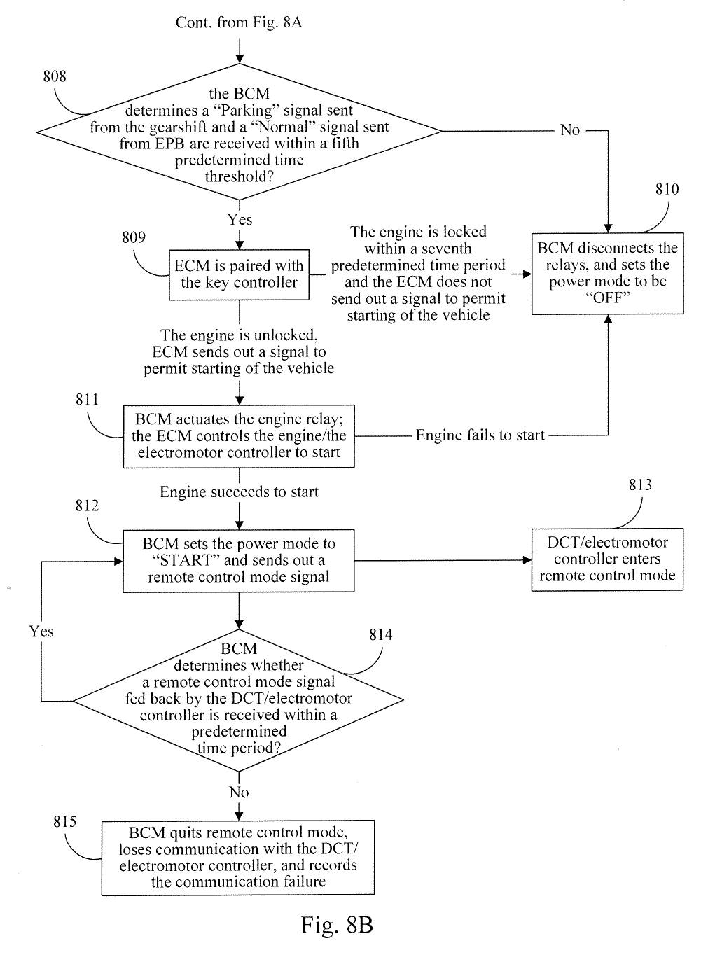

Referring to FIG. 5 and FIG. 6, the vehicle intelligent key device 102 consistent with embodiments of the present disclosure will be described in detail.

FIG. 5 is a block diagram showing a vehicle intelligent key device 102 consistent with embodiments of the present disclosure. As shown in FIG. 5, the vehicle intelligent key device 102 includes a starting key 501, direction control keys 502, a wireless communication module 503, and a control module 504.

When the starting key 501 is activated by a user, for example, when the starting key 501 is pressed down for a time period greater than a third time threshold, the vehicle intelligent key device 102 modulates relevant information and a start command, and sends them as a high frequency signal. The high frequency receiving device 103 of the vehicle 101 receives and demodulates the high frequency signal, and sends to the key controller 201 of the vehicle 101. The key controller 201 authenticates the signal, and sends out a “Start” message. In one exemplary embodiment of the present disclosure, the third time threshold may be 2 seconds.

On the other hand, when the starting key 501 is shortly pressed down, the vehicle intelligent key device 102 modulates relevant information and the start command, and sends them as a high frequency signal. The high frequency receiving device 103 of the vehicle 101 receives and modulates the high frequency signal, and sends to the key controller 201 of the vehicle 101. The key controller 201 authenticates the signal, and sends out a “Stop” message to control the vehicle 101 to stop the engine/power system.

FIG. 6 is a schematic view of a control panel of a vehicle intelligent key device 102 according to an exemplary embodiment of the present disclosure. As shown in FIG. 6, the direction control keys 502 comprise at least one of a left turning key 603, a right turning key 604, a forward key 601, and a backward key 602.

Consistent with embodiments of the present disclosure, when the forward key 601 is activated by the user, the vehicle intelligent key device 102 modulates relevant information and a forward command, and sends them as a high frequency signal. The high frequency receiving device 103 of the vehicle 101 receives and demodulates the high frequency signal, and sends to the key controller 201 of the vehicle 101. The key controller 201 authenticates the signal, and sends out a “Drive” message to control the vehicle 101 to move forward at a low speed. In one exemplary embodiment of the present disclosure, the vehicle 101 may move forward at a speed lower than 2 km/h. If the user releases the forward key 601, the vehicle 101 stops.

Consistent with embodiments of the present disclosure, when the backward key 602 is activated by the user, the vehicle intelligent key device 102 modulates relevant information and a backward command, and sends them as a high frequency signal. The high frequency receiving device 103 of the vehicle 101 receives and demodulates the high frequency signal and sends to the key controller 201 of the vehicle 101. The key controller 201 authenticates the signal, and sends out a “Backward” message to control the vehicle 101 to move backward at a low speed. In one exemplary embodiment of the present disclosure, the vehicle 101 may move backward at a speed lower than 2 km/h. If the user releases the backward key 602, the vehicle stops.

Consistent with embodiments of the present disclosure, when the left turning key 603 is activated by the user, the vehicle intelligent key device 102 modulates relevant information and a left turn command, sends them as a high frequency signal. The high frequency receiving device 103 of the vehicle 101 receives and demodulates the high frequency signal and sends to the key controller 201 of the vehicle 101. The key controller 201 authenticates the signal, and sends out a “Left turn” message to control the steering wheel of the vehicle 101 to turn left. If the user releases the left turn key 603, the vehicle stops turning left.

Consistent with embodiments of the present disclosure, when the right turning key 604 is activated by the user, the vehicle intelligent key device 102 modulates relevant information and a right turn command, and sends them as a high frequency signal. The high frequency receiving device 103 of the vehicle 101 receives and demodulates the high frequency signal and sends to the key controller 201 of the vehicle 101. The key controller 201 authenticates the signal, and sends out a “Right turn” message to control the steering wheel of the vehicle 101 to turn right. If the user releases the right turning key 604, the vehicle stops turning right.

The direction control keys 502 may be effective when the starting key 501 is activated to start a remote control mode. The left turning key 603, the right turning key 604, the forward key 601, and the backward key 602 may not be operated at the same time. For example, the user may not control the vehicle 101 to turn left or right when controlling the vehicle 101 to move forward or to move backward using the forward key 601 or the backward key 602. That is, it may be invalid to press down the left turning key 603 or the right turning key 604 during the forward or backward moving of the vehicle 101. Similarly, the user may not control the vehicle 101 to move forward or to move backward when controlling the vehicle to turn left or right using the left turning key 603 or the right turning key 604. That is, it may be invalid to press down the forward key 601 or the backward key 602 during the left or right turning of the vehicle 101.

Referring to FIG. 5 and FIG. 6, the vehicle intelligent key device 102 consistent with embodiments of the present disclosure may further comprise a locking key 607, an unlocking key 608, a trunk opening key 609, and a holding key 605.

Consistent with embodiments of the present disclosure, the locking key 607 is coupled to the control module 504. The control module 504 is further configured to control the wireless communication module 503 to send a locking signal to the vehicle 101 when the locking key 607 is activated. In other words, when the locking key 607 is activated by the user, the vehicle intelligent key device 102 modulates relevant information and a locking command, and sends them as a high frequency signal. The high frequency receiving device 103 of the vehicle 101 receives and demodulates the high frequency signal, and sends to the key controller 201 of the vehicle 101. The key controller 201 authenticates the signal, and sends out a “Remote locking” message. Further, before remotely controlling of the vehicle, the vehicle could be locked using the locking key 607, so as to avoid a mis-operation.

Consistent with embodiments of the present disclosure, the unlocking key 608 is coupled to the control module 504. The control module 504 is further configured to control the wireless communication module 503 to send an unlocking signal to the vehicle 101 when the unlocking key 608 is activated. In other words, when the unlocking key 608 is activated by the user, the vehicle intelligent key device 102 modulates relevant information and an unlocking command, and sends them as a high frequency signal. The high frequency receiving device 103 of the vehicle 101 receives and demodulates the high frequency signal, and sends to the key controller 201 of the vehicle 101. The key controller 201 authenticates the signal, and sends out a “Remote unlocking” message. Further, the vehicle could be unlocked to quit the remote control mode by activating the unlocking key 608 to unlock the vehicle.

Similarly, consistent with embodiments of the present disclosure, the control module 504 is further configured to control the wireless communication module 503 to send a trunk opening signal to the vehicle 101 when the trunk opening key 609 is activated. In other words, when the trunk opening key 609 is activated by the user, the vehicle intelligent key device 102 modulates relevant information and a trunk opening command, and sends them as a high frequency signal. The high frequency receiving device 103 of the vehicle 101 receives and demodulates the high frequency signal, and sends to the key controller 201 of the vehicle 101. The key controller 201 authenticates the signal, and sends out a “Remote trunk opening” message.

Consistent with embodiments of the present disclosure, the holding key 605 is coupled to the control module 504. The control module 504 is further configured to lock the keys of the vehicle intelligent key device 102 when the holding key 605 is activated. In other words, when the holding key 605 is activated by the user, the vehicle intelligent key device 101 modulates relevant information and a holding command, and sends them as a high frequency signal. The high frequency receiving device 103 of the vehicle 101 receives and demodulates the high frequency signal, and sends to the key controller 201 of the vehicle 101. The key controller 201 authenticates the signal, and sends out a “Holding” message. Thus, the mis-operation may be avoided.

In some embodiments of the present disclosure, the vehicle intelligent key device 102 may further comprise an indicator 606 configured to indicate remaining battery of the vehicle intelligent key device 102. The indicator 606 may be red. Furthermore, the indicator 606 may be on for a time period when the vehicle intelligent key device 101 sends out a signal. In one exemplary embodiment of the present disclosure, the time period may be 250 milliseconds. When the indicator 606 appears normal, it indicates that the vehicle intelligent key device 102 operates normally, while when the indicator light 606 is dim, it indicates that the remaining battery of the vehicle intelligent key device 102 is low or the signal is too weak.

In some embodiments of the present disclosure, the vehicle intelligent key device 102 may further comprise a transponder configured to communicate wirelessly with the vehicle 101 when the wireless communication module 503 is interfered. The transponder is also configured to communicate wirelessly with the vehicle 101 when the vehicle intelligent key device 102 does not have a battery or the remaining battery of the vehicle intelligent key device 102 is low.

With the vehicle intelligent key device 102 consistent with embodiments of the present disclosure, users could control the vehicle 101 to start, to move forward, to move backward, or to turn left or right at a low speed within a visual range (for example, within about 10 meters away from the vehicle 101) through the start key 501 and the direction control keys 502. Thus, it is possible to realize various controls of the vehicle 101 outside the vehicle 101, and for users to park or take the vehicle in narrow spaces. The operation of the vehicle intelligent key device 102 is also simple and convenient.

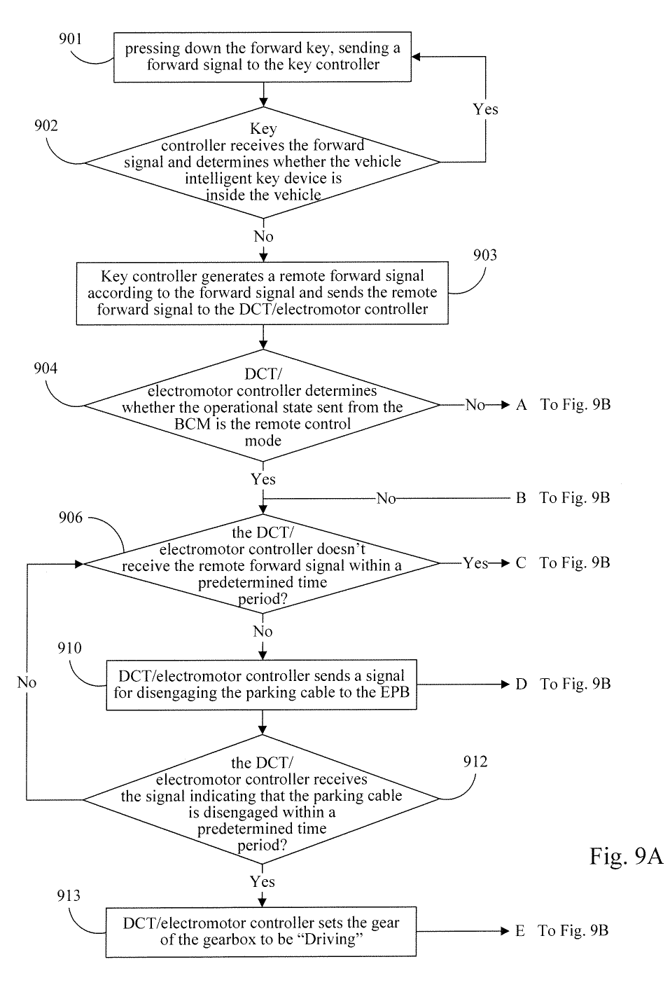

Referring to FIG. 7 to FIG. 13, remote control methods consistent with embodiments of the present disclosure for remotely driving a vehicle are described in detail.

FIG. 7 is a flow chart showing a remote control method consistent with embodiments of the present disclosure for remotely driving a vehicle. As shown in FIG. 7, the remote control method comprises the following.

At step 701, the vehicle intelligent key device 102 generates a starting signal or a control signal when the vehicle intelligent key device 102 is activated by the user, and sends the starting signal or the control signal to the vehicle 101.

At step 702, the vehicle 101 receives the starting signal from the vehicle intelligent key device 101, and unlocks and starts the engine and/or the power system of the vehicle 101 to start a remote control mode according to the starting signal.

At step 703, the vehicle 101 receives the control signal from the vehicle intelligent key device 101, and controls an operational state of the vehicle 101 according to the control signal, when the vehicle 101 is in the remote control mode. Controlling the operational state of the vehicle 101 may comprise controlling the steering system, the speed control system, or the braking system of the vehicle 101.

In one exemplary embodiment of the present disclosure, the starting signal and the control signal may be high-frequency signals.

In some embodiments of the present disclosure, the high frequency receiving device 103 of the vehicle 101 receives and demodulates the starting signal and the control signal sent by the vehicle intelligent key device 102, and sends to the key controller 201 of the vehicle 101. The key controller 201 generates a remote starting signal or a remote control signal according to the starting signal or the control signal. The remote control signal may be a remote forward signal, a remote backward signal, or a remote turning signal.

In addition, the key controller 201 of the vehicle 101 may detect whether the vehicle intelligent key device 102 is within the vehicle 101 after receiving the starting signal or the control signal. If the vehicle intelligent key device 102 is outside the vehicle 101, the key controller 201 may send the remote starting signal or the remote control signal to a body control module 202 of the vehicle 102.

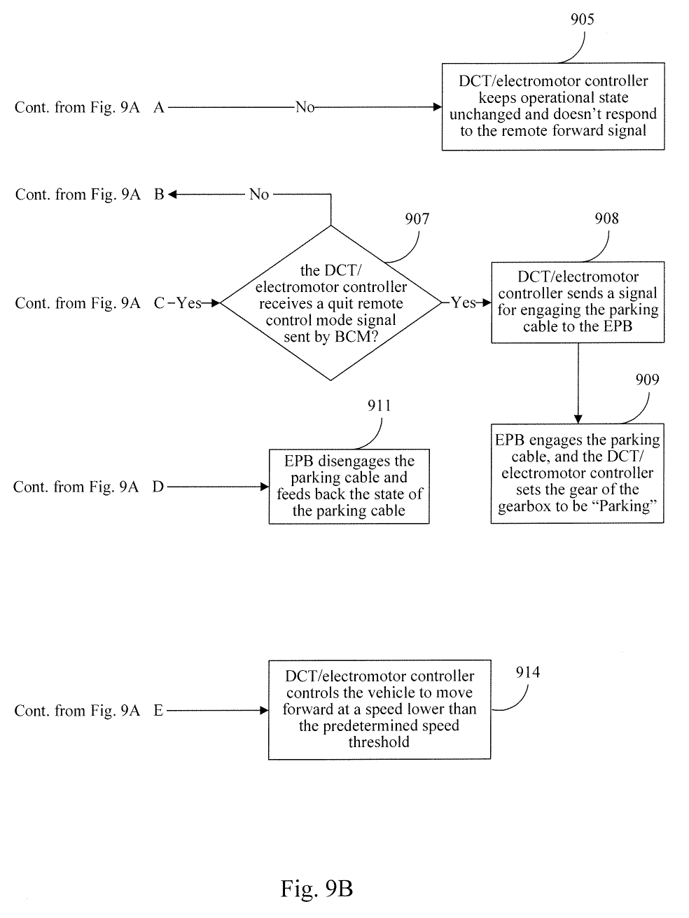

FIGS. 8A and 8B show a flow chart showing an exemplary process consistent with embodiments of the present disclosure for controlling the vehicle 101 to unlock the engine and/or the power system of the vehicle 101 and start the engine and/or the power system to enter the remote control mode. As shown in FIGS. 8A and 8B, the process comprises the following.

At step 801, the user presses down the locking key 607 to keep the vehicle 101 in a locking state. Within a fourth time threshold after the locking key 607 is pressed down, the user presses down the starting key 501 and holds for the third time threshold. Thus, the intelligent key device 102 sends a starting signal to the vehicle 101. In one exemplary embodiment, the third time threshold may be 2 seconds, the fourth time threshold may be 5 seconds.

At step 802, the key controller 201 of the vehicle 101 receives the starting signal and determines whether the vehicle intelligent key device 102 is inside the vehicle. If yes, the process returns to 801; if no, the process proceeds to step 803.

At step 803, the key controller 201 generates a remote starting signal according to the starting signal and sends the remote starting signal to the BCM 202.

At step 804, the BCM 202 receives the remote starting signal sent by the key controller 201, and determines whether all vehicle doors, the hood, and the trunk cover are closed. That is, the vehicle 101 is in a burglary prevention setting or a burglary prevention state.

At step 805, the BCM 202 sends an unlocking signal to the ECL 203. If the unlocking is failed, the process proceeds to 806. If the unlocking is successful, the process proceeds to step 807.

At step 806, the BCM 202 controls an indicator of the starting key to flash and controls an alarm to buzz. For example, the BCM 202 feeds back an unlocking failure signal to the vehicle intelligent key device 102 and controls an orange indicator of the starting key 501 to flash and the alarm to buzz once.

At step 807, the BCM 202 sets the power mode to “ON”, and sends out a pairing operation signal. For a fuel vehicle, the BCM 202 actuates relays, such as an ACC relay, an IG1 relay, and an IG2 relay, sets the power mode to “ON”, and sends out a pairing operation signal.

At step 808, the BCM 202 determines whether a “Parking” signal sent by the gearshift and a “Normal” signal sent by the EPB 208 are received within a fifth time threshold. If yes, the process proceeds to 809; if no, the process proceeds to 810. In other words, if the BCM 202 receives the “Parking” signal sent by the gearshift and the “Normal” signal sent by the EPB 208 within the fifth time threshold, goes to step 809; otherwise, goes to step 810. In one exemplary embodiment, the fifth time threshold may be 1 second.

At step 809, the ECM 205 is paired with the key controller 201. If the pairing operation is successful, the burglary prevention of the engine is removed, the ECM 205 sends out a start permitting signal to permit starting of the vehicle 101, and the process proceeds to 811. If the burglary prevention of the engine is not removed within a sixth time threshold (for example, 2 seconds, counting from the pairing operation signal is sent out) and the ECM 205 does not send out the start permitting signal, the pairing operation is determined to be failed, and the process proceeds to step 810.

At step 810, the BCM 202 disconnects the ACC relay, the IG1 relay, and the IG2 relay, and sets the power mode to “OFF”.

At step 811, the BCM 202 actuates an engine relay, and the ECM 205 controls the engine (for a fuel vehicle) to ignite and start or the electromotor controller 206 controls the vehicle to start (for an electric vehicle). If the engine fails to start, goes to step 810; otherwise, goes to step 812.

At step 812, the BCM 202 sets the power mode to “START” and sends out a remote control mode signal.

At step 813, the DCT (for a fuel vehicle)/the electromotor controller (for an electric vehicle) enters a remote control mode.

At step 814, the BCM 202 determines whether the remote control mode signal is fed back by the DCT (for a fuel vehicle)/the electromotor controller (for an electric vehicle) within a predetermined time period (for example, 2 seconds). If yes, the process returns to 812; if not, the process proceeds to step 815.

At step 815, the BCM 202 quits the remote control mode, loses communication with the DCT (for a fuel vehicle)/the electromotor controller (for an electric vehicle), and records the communication failure.

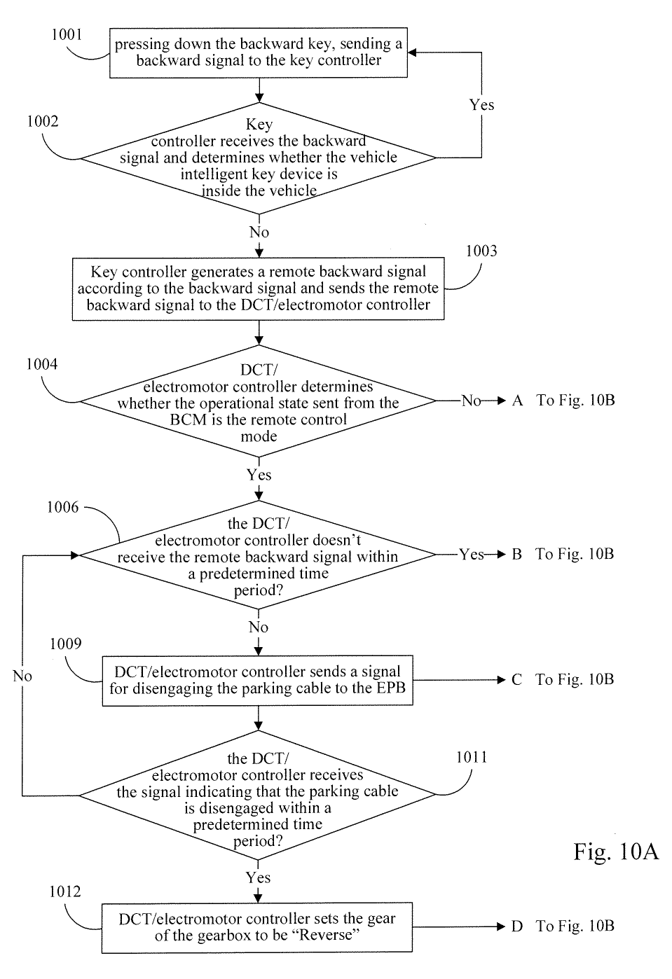

FIGS. 9A and 9B show a flow chart showing a process for controlling a vehicle to move forward according to an exemplary embodiment of the present disclosure. As shown in FIGS. 9A and 9B, according to one exemplary embodiment of the present disclosure, after the vehicle 101 enters the remote control mode, controlling the vehicle 101 to move forward further comprises the following.

At step 901, the forward key 601 of the vehicle intelligent key device 102 is pressed down, and a forward signal is sent to the key controller 201 of the vehicle 101.

At step 902, the key controller 201 receives the forward signal and determines whether the vehicle intelligent key device 102 is inside the vehicle 101. If yes, return to step 901, if no, execute step 903.

At step 903, the key controller 201 generates a remote forward signal according to the forward signal and sends the remote forward signal to the DCT (for a fuel vehicle)/the electromotor controller (for an electric vehicle).

At step 904, the DCT (for a fuel vehicle)/the electromotor controller (for an electric vehicle) determines whether the operational state sent by the BCM 202 is the remote control mode. If yes, execute step 906; if no, execute step 905.

At step 905, the DCT (for a fuel vehicle)/the electromotor controller (for an electric vehicle) keeps the operational state unchanged and does not respond to the remote forward signal.

At step 906, it is determined whether the DCT (for a fuel vehicle)/the electromotor controller (for an electric vehicle) receives the remote forward signal sent by the key controller 201 within a predetermined time period (for example, 100 ms). If no, execute step 907; if yes, execute step 910.

At step 907, it is determined whether the DCT (for a fuel vehicle)/the electromotor controller (for an electric vehicle) receives a quit remote control signal sent by the BCM 202. If yes, execute step 908; if no, return to step 906.

At step 908, the DCT (for a fuel vehicle)/the electromotor controller (for an electric vehicle) sends an engage parking cable signal to the EPB 208.

At step 909, the EPB 208 engages the parking cable, and the DCT (for a fuel vehicle)/the electromotor controller (for an electric vehicle) sets the gear of the gearbox to “Parking”.

At step 910, the DCT (for a fuel vehicle)/the electromotor controller (for an electric vehicle) sends a signal for disengaging the parking cable to the EPB 208.

At step 911, the EPB 208 disengages the parking cable and feeds back the state of the parking cable.

At step 912, it is detected whether the DCT (for a fuel vehicle)/the electromotor controller (for an electric vehicle) receives the signal indicating that the parking cable is disengaged within a predetermined time period, such as 2 seconds. If yes, execute step 913, if no, return to step 906.

At step 913, the DCT (for a fuel vehicle)/the electromotor controller (for an electric vehicle) sets the gear of the gearbox to “Driving”.

At step 914, the DCT (for a fuel vehicle)/the electromotor controller (for an electric vehicle) controls the vehicle 101 to move forward at a speed lower than the speed threshold (for example, 2 km/h).

Briefly, when a user presses down the forward key 601, the gear of the gearbox is switched to “Driving”, the parking cable of the electrical parking brake 208 is disengaged, and the vehicle 101 moves forward. If the user releases the forward key 601, the parking cable of the electrical parking brake 208 is engaged; the gear of the gearbox is set to “Parking”, and the vehicle stops.

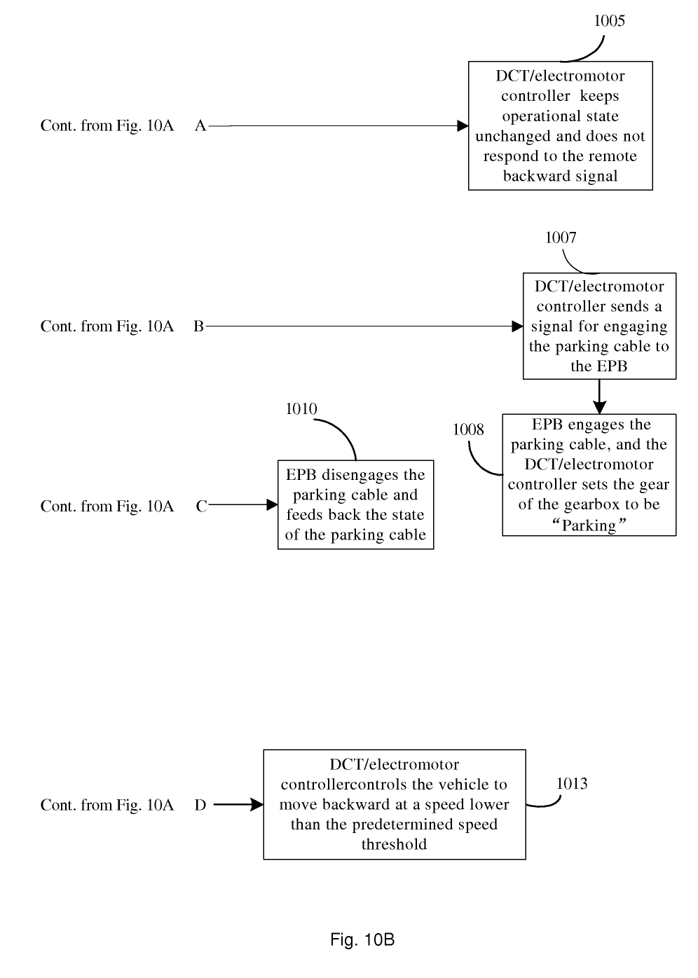

FIGS. 10A and 10B show a flow chart showing a process for controlling a vehicle to move backward according to one exemplary embodiment of the present disclosure. As shown in FIGS. 10A and 10B, after the vehicle 101 enters the remote control mode, controlling the vehicle 101 to move backward further comprises the following.

At step 1001, the backward key 602 of the vehicle intelligent key device 102 is pressed down, and a backward signal is sent to the key controller 201 of the vehicle 101.

At step 1002, the key controller 201 receives the backward signal and determines whether the vehicle intelligent key device 102 is inside the vehicle 101. If yes, return to step 1001, if no, execute step 1003.

At step 1003, the key controller 201 generates a remote backward signal according to the backward signal and sends the remote backward signal to the DCT (for a fuel vehicle)/the electromotor controller (for an electric vehicle).

At step 1004, the DCT (for a fuel vehicle)/the electromotor controller (for an electric vehicle) determines whether the operational state sent by the BCM 202 is the remote control mode. If yes, execute step 1006; if no, execute step 1005.

At step 1005, the DCT (for a fuel vehicle)/the electromotor controller (for an electric vehicle) keeps the operational state unchanged and does not respond to the remote backward signal.

At step 1006, it is determined whether the DCT (for a fuel vehicle)/the electromotor controller (for an electric vehicle) receives the remote backward signal sent by the key controller 201 within a predetermined time period (for example, 100 ms). If no, execute step 1007; if yes, execute step 1009.

At step 1007, the DCT (for a fuel vehicle)/the electromotor controller (for an electric vehicle) sends an engage parking cable signal to the EPB 208.

At step 1008, the EPB 208 engages the parking cable, and the DCT (for a fuel vehicle)/the electromotor controller (for an electric vehicle) sets the gear of the gearbox to “Parking”.

At step 1009, the DCT (for a fuel vehicle)/the electromotor controller (for an electric vehicle) sends a signal for disengaging the parking cable to the EPB 208.

At step 1010, the EPB 208 disengages the parking cable and feeds back the state of the parking cable.

At step 1011, it is detected whether the DCT (for a fuel vehicle)/the electromotor controller (for an electric vehicle) receives the signal indicating that the parking cable is disengaged within a predetermined time period, such as 2 seconds. If yes, execute step 1012, if no, return to step 1006.

At step 1012, the DCT (for a fuel vehicle)/the electromotor controller (for an electric vehicle) sets the gear of the gearbox to “Reverse”.

At step 1013, the DCT (for a fuel vehicle)/the electromotor controller (for an electric vehicle) controls the vehicle 101 to move backward at a speed lower than the speed threshold (for example, 2 km/h).

Briefly, when a user presses down the backward key 602, the gear of a gearbox is switched to “Reverse”, the parking cable of the electrical parking brake 208 is disengaged, and the vehicle 101 moves backward. If the user releases the backward key 602, the parking cable of the electrical parking brake 208 is engaged, the gear of the gearbox is set to “Parking”, and the vehicle 101 stops.

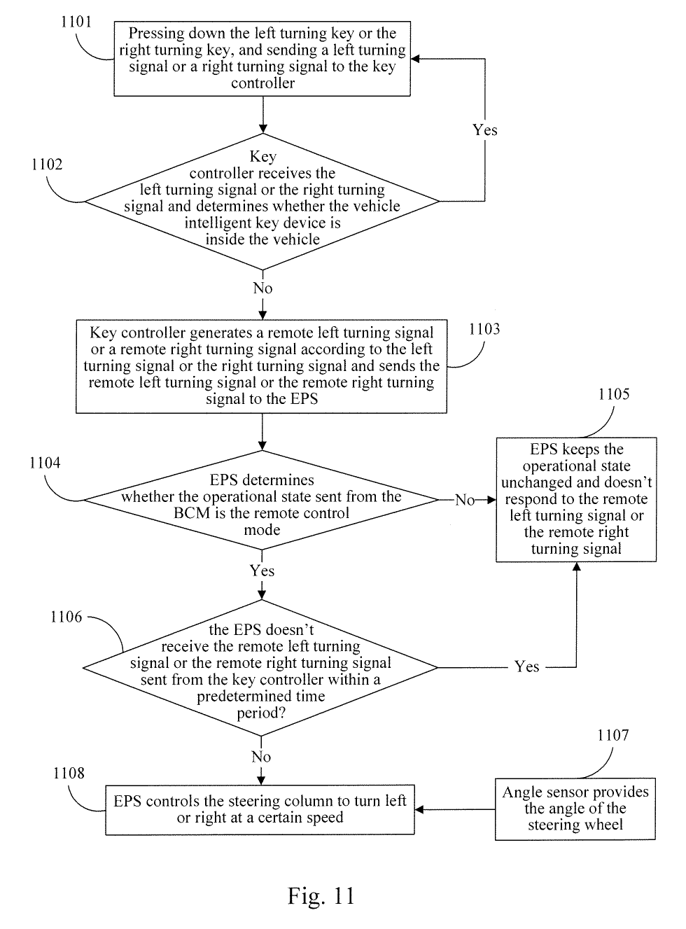

FIG. 11 is a flow chart showing a process for controlling a vehicle to turn left or right according to one exemplary embodiment of the present disclosure. As shown in FIG. 11, after the vehicle 101 enters the remote control mode, controlling the vehicle 101 to turn left or right further comprises the following.

At step 1101, the left turning key 603 or the right turning key 604 of the vehicle intelligent key device 102 is pressed down, and a left turning signal or a right turning signal is sent to the key controller 201 of the vehicle 101.

At step 1102, the key controller 201 receives the left turning signal or the right turning signal, and determines whether the vehicle intelligent key device 102 is inside the vehicle 101. If yes, returns to step 1101, if no, goes to step 1103.

At step 1103, the key controller 201 generates a remote left turning signal or a remote right turning signal according to the left turning signal or the right turning signal, and sends the remote left turning signal or the remote right turning signal to the EPS 401.

At step 1104, the EPS 401 determines whether the operational state sent by the BCM 202 is the remote control mode. If yes, goes to step 1106; if no, goes to step 1105.

At step 1105, the EPS 401 keeps the operational state of the vehicle 101 unchanged and does not respond to the remote left turning signal or the remote right turning signal.

At step 1106, it is determined whether the EPS 401 receives the remote left turning signal or remote right turning signal sent from the key controller 201 within a predetermined time period (for example, 100 ms). If no, goes to step 1105; if yes, goes to step 1108.

At step 1107, the angle sensor 402 provides the angle of the steering wheel, that is, the angle sensor 402 detects the rotation angle of the steering wheel and feeds back the rotation angle to the electric power steering module 401.

At step 1108, the EPS 401 controls the steering column to turn left or right at a certain speed.

Briefly, when a user presses down the left turning key 603, the electric power steering module 401 controls the steering wheel to turn left; and if the user releases the left turning key 603, the steering wheel stops turning left. When a user presses down the right turning key 604, the electric power steering module 401 controls the steering wheel to turn right; and if the user releases the right turning key 604, the steering wheel stops turning right.

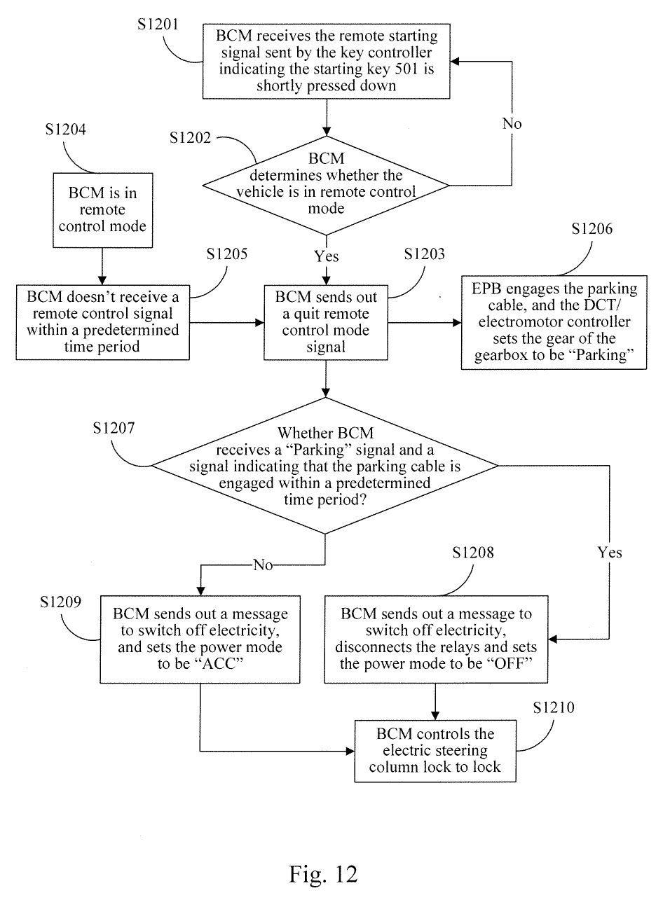

FIG. 12 is a flow chart showing a process for controlling a vehicle to quit the remote control mode according to an exemplary embodiment of the present disclosure. As shown in FIG. 12, in one exemplary embodiment of the present disclosure, controlling the vehicle 101 to quit the remote control mode further comprises the following.

At step 1201, the BCM 202 receives the remote starting signal sent by the key controller 201 indicating the starting key 501 is shortly pressed down.

At step 1202, the BCM 202 determines whether the vehicle 101 is in the remote control mode. If yes, execute step 1203, if no, return to step 1201.

At step 1203, the BCM 202 sends out a quit remote control mode signal.

Consistent with embodiments of the present disclosure, other scenarios may also trigger the execution of step 1203. For example, as shown in FIG. 12, at step 1204, the vehicle 101 is already in the remote control mode.

At step 1205, it is detected that the BCM 202 does not receive a remote forward signal, a remote backward signal, or a remote turning signal within a predetermined time period (for example, 10 minutes). As a result, the process proceeds to step 1203.

At step 1206, the EPB 208 engages the parking cable, and the DCT (for a fuel vehicle)/the electromotor controller (for an electric vehicle) sets the gear of the gearbox to “Parking”.

At step 1207, it is detected whether the BCM 202 receives a “Parking” signal and a signal indicating that the parking cable is engaged within a predetermined time period (for example, 2 seconds). If yes, goes to step 1208, if no, goes to step 1209.

At step 1208, the BCM 202 sends out a message to turn off electricity, disconnects the ACC relay, the IG1 relay, and the IG3 relay, and sets the power mode to “OFF”.

At step 1209, the BCM 202 sends out a message to turn off electricity, and sets the power mode to “ACC”.

At step 1210, the BCM 202 controls the electric steering column lock 203 to lock.

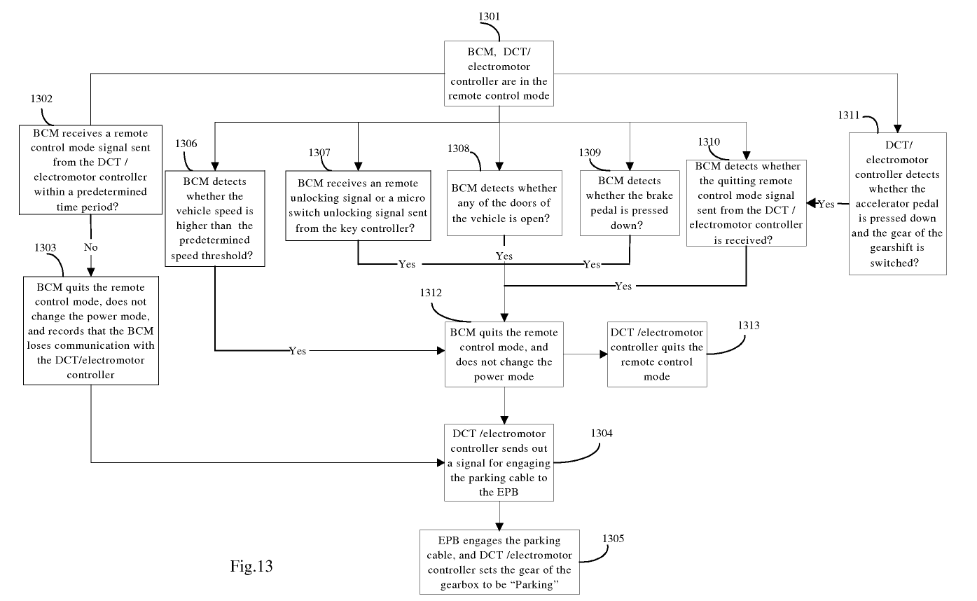

FIG. 13 is a flow chart showing a process for controlling a vehicle to quit the remote control mode according to another exemplary embodiment of the present disclosure. As shown in FIG. 13, in another exemplary embodiment of the present disclosure, controlling the vehicle 101 to quit the remote control mode further comprises the following.

At step 1301, the BCM 202, the DCT (for a fuel vehicle)/the electromotor controller (for an electric vehicle) are in the remote control mode.

At step 1302, it is detected that the BCM 202 does not receive a remote control mode signal (indicating the vehicle 101 is in the remote control mode) sent by the DCT (for a fuel vehicle)/the electromotor controller (for an electric vehicle) within a predetermined time period (for example, 2 seconds). As a result, the process proceeds to step 1303.

At step 1303, the BCM 202 quits the remote control mode (under normal driving mode), does not change the power mode, and records that the BCM 202 loses communication with the DCT (for a fuel vehicle)/the electromotor controller (for an electric vehicle). The process proceeds to step 1304.

At step 1304, the DCT (for a fuel vehicle)/the electromotor controller (for an electric vehicle) sends out an engage parking cable signal to the EPB 208.

At step 1305, the EPB 208 engages the parking cable, and the DCT (for a fuel vehicle)/the electromotor controller (for an electric vehicle) sets the gear of the gearbox to “Parking”.

Consistent with embodiments of the present disclosure, there are other scenarios that may trigger the execution of step 1304, as described in more detail below.

At step 1306, the BCM 202 detects that the vehicle speed is higher than the speed threshold (for example, 2 km/h) or the speed signal is failed to be detected. The process proceeds to step 1312.

At step 1307, the BCM 202 receives a remote unlocking signal or a micro switch unlocking signal sent by the key controller 201. The process proceeds to step 1312.

At step 1308, the BCM 202 detects that at least one of the vehicle doors is open. The process proceeds to step 1312.

At step 1309, the BCM 202 detects that the brake pedal is pressed down. The process proceeds to step 1312.

At step 1310, the BCM 202 receives a quit remote control mode signal sent by the DCT (for a fuel vehicle)/the electromotor controller (for an electric vehicle). The process proceeds to step 1312.

In addition, when the DCT (for a fuel vehicle)/the electromotor controller (for an electric vehicle) detects that the accelerator pedal is pressed down and the gear of the gearshift is switched (step 1311), the process also proceeds to step 1310.

At step 1312, the BCM 202 quits the remote control mode (under normal driving mode), and does not change the power mode. On the one hand, an engage parking cable signal is sent to the EPB 208 (step 1304). On the other hand, the DCT (for a fuel vehicle)/the electromotor controller (for an electric vehicle) quits the remote control mode (step 1313).

Steps step 1302, step 1306, step 1307, step 1308, step 1309, step 1310, and step 1311 may be executed simultaneously or sequentially, and the order thereof could be changed. Furthermore, as long as one of the conditions described above is satisfied, the vehicle 101 will quit the remote control mode.

In brief, the vehicle 101 quits the remote control mode if any one of the following conditions is satisfied.

(1) No remote controlling operation is performed after the first time threshold

(for example, 10 minutes). At this time, the parking cable of the electrical parking brake 208 is engaged, the gear of the gearbox is set to “Parking”, the vehicle 101 stops, quit the remote control mode, the vehicle 101 shuts down, and the electric steering column lock 203 is locked.

(2) The starting key 501 is shortly pressed down. At this time, the parking cable of the electrical parking brake 208 is engaged, the gear of the gearbox is set to “Parking”, the vehicle 101 stops, quits the remote control mode, the vehicle 101 shuts down, and the electric steering column lock 203 is locked.

(3) The vehicle intelligent key device 102 or a micro switch is unlocked or a door of the vehicle 101 opens. At this time, the parking cable of the electrical parking brake 208 is engaged, the gear of the gearbox is set to “Parking”, the vehicle 101 stops, and quit the remote control mode, but the vehicle 101 does not shut down.

(4) An accelerator pedal or a brake pedal is pressed down, or the gear of a gear lever is switched. At this time, the vehicle 101 quits the remote control mode, but does not shut down.

(5) The vehicle speed is higher than the speed threshold, for example higher than 2 km/h, or a vehicle speed signal is faulty. At this time, the vehicle 101 quits the remote control mode, but does not shut down.

The purpose of quitting the remote control mode may include: preventing the user from driving the vehicle 101 in the remote control mode, preventing the user from forgetting to shut down the vehicle 101 after the vehicle 101 is in the remote control mode for a long time, and preventing the vehicle 101 from losing the remote control function when the control keys fail, so that the user could take emergency measures.

With the remote control method for driving a vehicle consistent with embodiments of the present disclosure, users could control the vehicle to start, move forward or move backward, or turn left or right within a visual range (for example, 10 meters) outside the vehicle. The control operation is also simple. Therefore, it is convenient for a user to park or take a vehicle in a narrow space.

Reference throughout this disclosure to “an embodiment,” “some embodiments,” “one embodiment”, or “embodiments,” means that a particular feature, structure, material, or characteristic described in connection with the embodiment or example is included in at least one embodiment or example of the present disclosure. Thus, the appearances of the phrases such as “in some embodiments,” “in one embodiment”, “in embodiments”, in various places throughout this disclosure do not necessarily refer to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles, and scope of the present disclosure.

What is claimed is:

1. A remote control system for remotely driving a passenger vehicle, comprising:
a key controller configured to receive a signal sent by a passenger vehicle intelligent key device, and to generate a remote signal according to the received signal;
a body control module configured to control the passenger vehicle to enter into a remote control mode according to the remote signal; and
an automatic transmission configured to control a gear of a gearbox of the passenger vehicle to switch according to the remote signal.

2. The remote control system according to claim 1,
wherein the remote signal includes a remote turning signal,
the system further comprising:
an electric power steering module configured to control a steering wheel of the passenger vehicle to rotate according to the remote turning signal when the passenger vehicle is in the remote control mode.

3. The remote control system according to claim 2, further comprising:
an angle sensor configured to detect a rotation angle of the steering wheel and to feed back the rotation angle to the electric power steering module.

4. The remote control system according to claim 1,
wherein body control module is further configured to generate an unlocking signal,
the system further comprising:
an electric steering column lock configured to unlock a steering wheel of the passenger vehicle according to the unlocking signal.

5. The remote control system according to claim 4, further comprising:
a gateway configured to communicate with the key controller, the body control module, and the electric steering column lock, respectively.

6. The remote control system according to claim 1,
wherein the remote signal includes a remote starting signal,
the system further comprising:
an engine control module configured to control an engine of the passenger vehicle to start according to the remote starting signal.

7. The remote control system according to claim 1,
wherein the automatic transmission is further configured to generate a parking control signal,
the system further comprising:
an electrical parking brake configured to control the passenger vehicle to park according to the parking control signal.

8. The remote control system according to claim 7, wherein the body control module is further configured to detect a state of the electrical parking brake and a gear of a gearbox of the passenger vehicle.

9. The remote control system according to claim 8, further comprising:
an engine control module,
wherein:
when the state of the electrical parking brake is normal and the gear of the gearbox of the passenger vehicle is at “Parking”, the engine control module and the key controller perform a pairing operation.

10. The remote control system according to claim 1, wherein:
the remote signal includes a remote control signal,
the automatic transmission is further configured to generate a remote control mode signal indicating the passenger vehicle is in the remote control mode,
the body control module is further configured to control the passenger vehicle to quit the remote control mode if any one of the following conditions is satisfied:
1) no remote control signal is detected by the body control module within a first time threshold,
2) no remote control mode signal is detected by the body control module within a second time threshold,
3) a quit remote control mode signal is detected by the body control module,
4) a vehicle door is detected by the body control module to be open,
5) a brake pedal or an accelerator pedal is detected by the body control module to be pressed down,
6) a vehicle speed is detected to be higher than a speed threshold or the vehicle speed is not detected by the body control module, or
7) a remote unlocking signal or a micro switch unlocking signal generated by the key controller is received by the body control module.

11. The remote control system according to claim 10, wherein the automatic transmission is further configured to generate an engaging signal for engaging a parking cable and to send the engaging signal to an electrical parking brake and to set a gear of a gearbox of the vehicle to “Parking” when the engine quits the remote control mode.

12. The remote control system according to claim 1, wherein:
the remote signal includes one of a remote forward signal, or a remote backward signal, and
the automatic transmission is further configured to, when the passenger vehicle is in the remote control mode, control an electrical parking brake to disengage a parking cable, to feed back a state of the parking cable, and to set a gear of a gearbox of the passenger vehicle to:
“Driving” when the automatic transmission receives the remote forward signal, or
“Reverse” when the automatic transmission receives the remote backward signal.

13. The remote control system according to claim 1, wherein automatic transmission is further configured to control the passenger vehicle to move forward or to move backward at a speed lower than a speed threshold.

14. The remote control system according to claim 1, wherein the key controller is further configured to, after receiving the signal, detect whether the passenger vehicle intelligent key device is outside the passenger vehicle, and to send the remote signal to the body control module when the passenger vehicle intelligent key device is outside the passenger vehicle.

15. A passenger vehicle intelligent key device comprising:
a starting key;
a direction control key;
a control module coupled to the starting key and the direction control key, the control module being configured to generate a signal when the starting key or the direction control key is activated; and
a wireless communication module coupled to the control module and configured to send the signal to passenger vehicle.

16. A remote control method for remotely driving a passenger vehicle, comprising:
receiving, by a key controller, a signal sent by a passenger vehicle intelligent key device;
generating, by the key controller, a remote signal according to the received signal;
controlling, by a body control module, the passenger vehicle to enter into a remote control mode according to the remote signal; and
controlling an operational state of the passenger vehicle according to the remote signal.

17. The remote control method according to claim 16,
wherein the remote signal is a remote turning signal,
the method further comprising:
detecting, when the remote turning signal is received, whether the passenger vehicle is in the remote control mode; and
controlling, when the passenger vehicle is in the remote control mode, a steering wheel of the passenger vehicle to rotate by an electric power steering module according to the remote turning signal.

18. The remote control method according to claim 17, further comprising:
detecting a rotation angle of the steering wheel by an angle sensor; and
feeding back the rotation angle to the electric power steering module.

19. The remote control method according to claim 16, further comprising:
detecting, after the signal is received, whether the passenger vehicle intelligent key device is outside the passenger vehicle; and
sending the remote signal to a body control module when the passenger vehicle intelligent key device is outside the passenger vehicle.

20. The remote control method according to claim 16,
wherein the remote signal includes a remote starting signal,
the method further comprising:
detecting a state of an electrical parking brake and a gear of a gearbox of the passenger vehicle after the body control module receives the remote starting signal;
pairing an engine control module and the key controller when the state of the electrical parking brake is normal and the gear of the gearbox is “Parking”; and
starting an engine of the passenger vehicle after the engine control module and the key controller are paired.
